(19) United States
(12) Patent Application Publication
(10) Pub. No.: US 2014/0173978 A1
(43) Pub. Date: Jun. 26, 2014

(54) GRASS PROTECTION MAT

(71) Applicants: Sin Kim, Daegu (KR); Kyung Bin Kim, Daegu (KR)

(72) Inventors: Sin Kim, Daegu (KR); Kyung Bin Kim, Daegu (KR)

(21) Appl. No.: 14/113,916

(22) PCT Filed: Apr. 24, 2012
(86) PCT No.: PCT/KR2012/003132

§ 371 Date: Feb. 4, 2014

(30) Foreign Application Priority Data
Apr. 27, 2011 (KR) 10-2011-0039445

(51) Int. Cl. A01G 13/00

(52) U.S. Cl. CPC A01G 13/0268
USPC 47/20.1

(57) ABSTRACT

The present invention relates to a grass protection mat which can be used in golf courses, grass fields, lawns and the like to protect grass while enduring pressure from being stepped on by people and loads from objects. The grass protection mat comprises: networked main body portions (10) in which hexagons are continuously repeated; a tetragonal border (11) finishing the edge; columns (20) vertically formed at each hexagonal corner of the main body portions; wall support bodies (30) formed on the upper surface of the networked main body portions (10) so as to be lower than the columns; upper protrusions (40) formed on the upper surface of the networked main body portions (10) so as to be higher than the columns; and Y-shaped lower connectors (50) for connecting three columns (20) among six columns forming a hexagon at the lower ends of the columns (20) so as to meet at the center of the hexagon. The networked main body portions (10) are connected into a hexagonal shape at an upper portion, and the lower connectors (50) are connected into a hexagonal shape at a lower portion in such a way that the hexagon formed by the lower connectors (50) are offset relative to the hexagon formed by the networked main body portions (10), thereby effectively enduring pressure from being stepped on by people and loads from objects.

### CROSS REFERENCE TO RELATED APPLICATION

The present application claims priority to International Application PCT/KR2012/003132, with an International Filing Date of Apr. 24, 2012, which claims the benefit of Korean Patent Application No. 10-2011-0039445 filed in the Korean Intellectual Property Office on Apr. 27, 2011, the entire contents of which are incorporated herein by reference.

### BACKGROUND OF THE INVENTION

1. Technical Field

The present invention relates to a grass protection mat which is constructed in golf courses, grass fields, lawns and so on in order to protect lawns from stepped pressure by moving people and load of an object and, more particularly, to a grass protection mat configured to effectively endure stepped pressure by people and load of an object, increase lifespan, and efficiently protect lawns.

2. Description of the Related Art

As known, a grass protection mat is increasingly used according to increasing golf courses or grass fields and a tendency of eco-friendly buildings and constructions, and thus it is necessary to improve lots of functions of the grass protection mat, such as solidity and the extension of lifespan, as well as the original function of protecting grass.

A recently developed grass protection mat has a general construction in which polygonal or circular basic frames are repeatedly connected and downwardly protruded supports columns and upwardly protruded buffering protrusion are continuously formed.

Such a conventional grass protection mat was problematic in that the grass protection mat is gradually stuck into the ground deeply and thus the grass protection mat digs up the ground or touches the roots of grass and further hinders the birth and breeding of grass because the lower protrusion columns of the grass protection mat directly come in contact with the surface of the land and unlimitedly dig into the surface of the land when installing grass protection mat.

Furthermore, if force applied to the grass protection mat is applied slantingly, polygonal coupling structures were scattered and thus twisting stress was repeatedly applied, leading to much reduced lifespan. Furthermore, the conventional grass protection mat is significantly disadvantageous in the birth and breeding of grass because the columns are tilted by slanted weight, soil is scratched and dug out, and thus the roots of grass are repeatedly touched.

Furthermore, the conventional grass protection mat is disadvantageous in that load is not well distributed when the load is applied and a hexagonal coupling structure is easily twisted because a hexagonal or circular structure is simply repeated and thus the lifespan of the grass protection mat is greatly reduced by the repetition of such actions.

### SUMMARY OF THE INVENTION

Accordingly, the present invention has been made keeping in mind the above problems occurring in the prior art, and an object of the present invention is to provide a grass protection mat configured to have a very solid connection state in such a way as to effectively endure stepped pressure according to use or load although the stepped pressure or load is applied to the grass protection mat very strongly or irregularly and non-uniformly, to have very long lifespan and reliability, and to effectively protect grass and stably maintain lawns.

In order to accomplish the above object, in constructing the grass protection mat, the present invention basically includes main body portions configured to have hexagons continuously repeated and a tetragonal border finishing edges of the grass protection mat, wherein columns are vertically formed at each hexagonal corner of the main body portions, wall support bodies are configured on the upper surfaces of the networked main body portions in such a way as to be lower than the columns, and upper protrusions are configured on the upper surfaces of the networked main body portions in such a way as to be higher than the columns.

Furthermore, Y-shaped lower connectors configured to gather three columns, from among six columns forming a hexagon, in the center of the hexagon at lower ends of the columns, wherein the network-shaped main body portions coupled in a hexagonal form and the lower connectors that cross the network-shaped main body portions on the lower side are coupled in a hexagonal form when being seen at the top.

### BRIEF DESCRIPTION OF THE DRAWINGS

FIG. 1 is the entire perspective view of a protection mat according to the present invention.

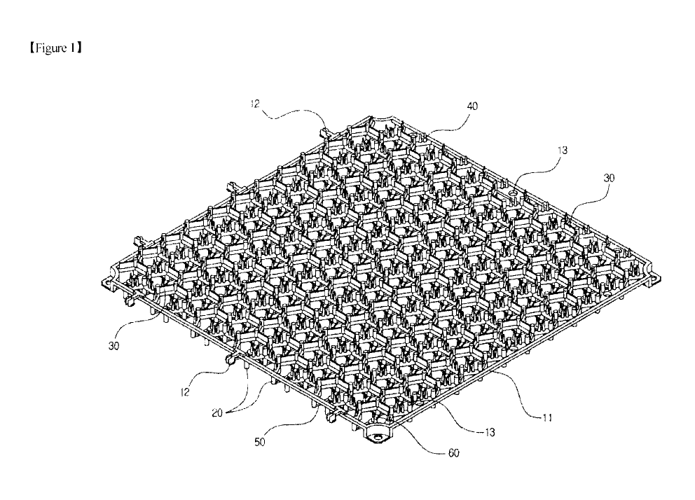

FIG. 2 is a partially enlarged perspective view of the protection mat according to the present invention.

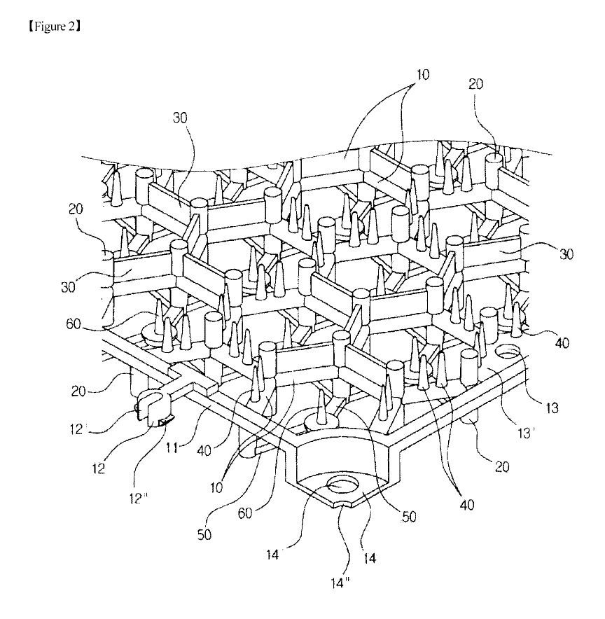

FIG. 3 is a partially enlarged back perspective view of the protection mat according to the present invention.

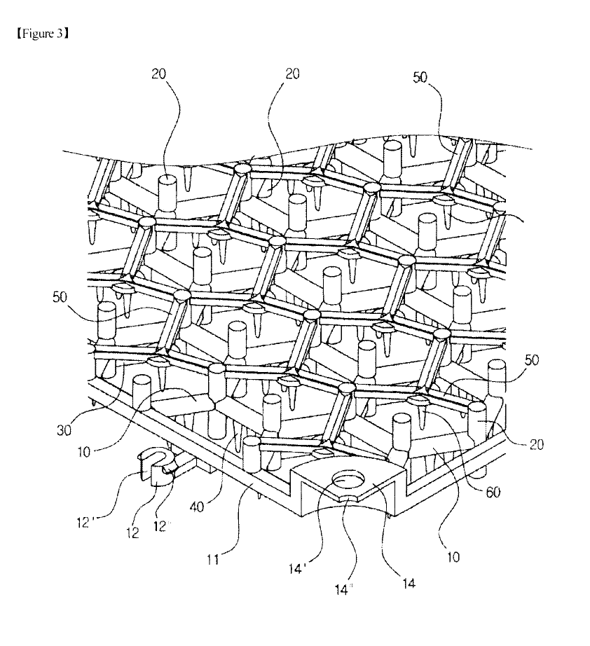

FIG. 4 is a front view of the protection mat according to the present invention.

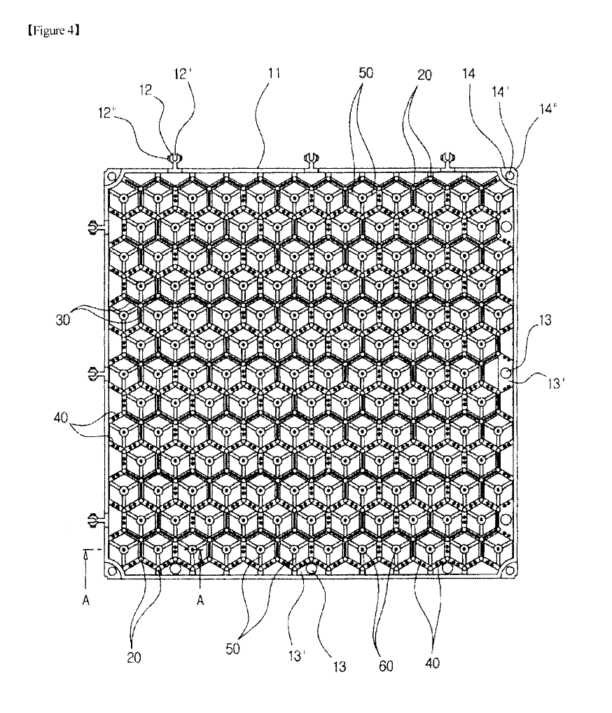

FIG. 5 is a front enlarged view showing the connection state of the protection mat according to the present invention.

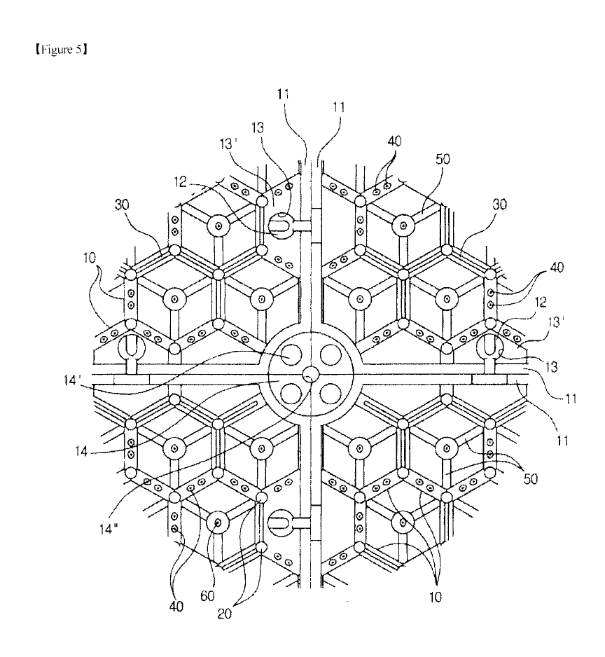

FIG. 6 is an enlarged cross-sectional view of line A-A of FIG. 4.

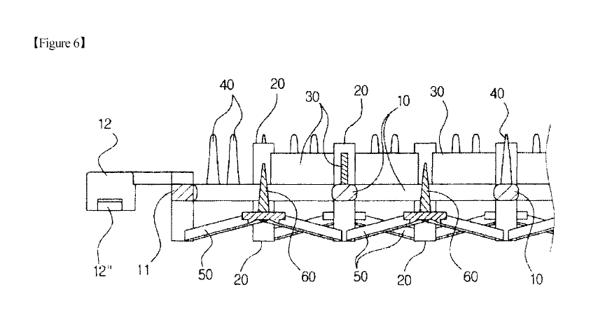

### DESCRIPTION OF REFERENCE NUMERALS OF PRINCIPAL ELEMENTS IN THE DRAWINGS

| | |
|---|---|
| 10: main body portion | 11: border |

| | |
|---|---|
| 12: coupling hole | 13: |

| coupling hole | |
|---|---|
| 14: corner connection portion | 20: column |

| | | |
|---|---|---|
| 30: support wall body | 40: | upper |

| protrusion | |
|---|---|
| 50: lower connector | 60: lower protrusion |

### DETAILED DESCRIPTION

Hereinafter, a preferred construction embodiment of the present invention is described in detail with reference to the accompanying drawings.

A grass protection mat of the present invention is finished in which hexagonal network-shaped main body portions 10 are continuously repeatedly configured, a tetragonal border 11 is formed at the edges of the grass protection mat, protruding coupling pieces 12 are formed at [symbol] -shaped two sides of the border 11, and coupling holes 13 with which the coupling pieces 12 are internally coupled are formed at [symbol] -shaped two sides on the other side.

The coupling piece 12 is protruded from the border and is circularly configured to have a groove 12′ for contraction. A latching protrusion 12″ for preventing the detachment of the latching protrusion 12″ after being inserted into the coupling hole 13 is formed on the side of the coupling piece 12. The coupling hole 13 includes a sheet body 13′ configured to fit the network-shaped main body portion 10 that is incomplete and hexagonal into the inside of the border 11, and the coupling hole 13 into which the coupling piece 12 is inserted is then formed in the center of the sheet body 13′.

A vertically column 20 is configured at each of the hexagonal corners of the network-shaped main body portions 10, thus performing a function of enduring up and down basic load (stepped pressure).

Furthermore, support wall bodies 30 and upper protrusions 40 are configured at a ratio of 1:2 at the upper surface of each of the hexagonal network-shaped main body portions 10. Each support wall body 30 couples the columns 20 protruded upwardly from the network-shaped main body portion 10 in a form, such as a wall, in the height slightly lower than the columns 20. The upper protrusions 40 include several conic protrusions that are formed slightly higher than the columns 20 of each network-shaped main body portion 10 between the columns 20.

In such an arrangement of the support wall bodies 30 and the upper protrusions 40, in the hexagon shape of the network-shaped main body portions 10, the support wall bodies 30 are consecutive in one string of a portion in which a [symbol] -shaped portion and a [symbol] -shaped portion are continuous in zigzags, and the upper protrusions 40 are continuous in the next string. The support wall bodies 30 or the upper protrusions 40 are connected to a portion where the string in which the support wall bodies 30 are continuous and the string in which the upper protrusions 40 are continuous are coupled at constant intervals, thereby forming a Y-shaped or a Y-shaped form having up and down opposite forms.

A Y-shaped lower connector 50 is configured at the lower end of the column 20 so that the lower ends of three columns 20, from among six columns forming a hexagon, are gathered at the central part of the hexagon. Accordingly, the network-shaped main body portions 10 coupled in a hexagonal form and the lower connectors 50 that cross the network-shaped main body portions 10 on a lower side are coupled in a hexagonal form when being seen at a top. As a result, the hexagons look overlapped.

The lower connector 50 is slantingly connected from the lower end of the column to an upper direction thereof. A lower protrusion 60 that is upwardly protruded is configured at a portion where the lower connectors 50 are gathered. The lower protrusion 60 is configured to have height lower than the upper end of the upper protrusion 40.

Corner connection portions 14 having the same height as the lower end of the column 20 are configured at four corners of the border 11, respectively. A fixed hole 14′ is formed at each of the corner connection portions 14, and a split hole 14″ split by ¼ is formed at the end of the corner connection portion 14. Upon installation, a pack may be driven in the fixed hole 14′ or the split hole 14″ formed by four grass protection mats.

An operation of the grass protection mat in accordance with the present invention is described below.

When installing the grass protection mat of the present invention, several grass protection mats are continuously arranged and coupled in horizontal and vertical directions. When the coupling pieces 12 on one side are pushed in the respective coupling holes 13 of another grass protection mat, each of the latching protrusions 12″ is contracted by the groove 12′ and then returned, thus remaining inserted into the coupling hole 13.

In this state, when it is necessary to firmly fix the grass protection mat to the surface of the land of a lawn, packs have only to be driven in the fixed holes 14′ or the split holes 14″.

After the grass protection mat is installed in a lawn, the lower ends of the columns 20 are slightly dug into the ground and thus become a stable state, and grass grows between the lower connectors 50 and the columns 20 on the lower side.

In this state, when a person steps on or an object presses the grass protection mat of the present invention, the network-shaped main body portions 10, the support wall bodies 30, and the columns 20 coupled together function to basically endure stepped pressure and maintain the shape of the grass protection mat.

Furthermore, in accordance with the present invention, since the grass protection mat has elasticity due to the upper protrusions 40 configured between the support wall bodies 30. When a person steps on the grass protection mat, the person can walk stably and safely while feeling a smooth cushion. Furthermore, the upper protrusions 40 function to remove soil stick to the bottom of a shoe.

In particular, in the present invention, a zigzagged string in which the support wall bodies 30 of the network-shaped main body portions 10 are formed has a continuous shape, and the support wall bodies 30 are also protruded in a direction orthogonal to the zigzagged string and configured in a Y form. Thus, although stepped pressure is applied from at any location or at any angle over the grass protection mat, pressure is uniformly applied to and stably supported by the support wall bodies 30, and the support wall bodies 30 can endure force that pushes the support wall bodies 30 in a lateral direction without being bent back.

Furthermore, although stepped pressure is not uniformly applied up and down directions, but is slantingly applied in an inclined direction, the middles of the columns 20 are coupled by the network-shaped main body portions 10 and the lower ends of halves of the columns are also coupled by the lower connectors 50, thus forming a well weaved organization, such as a network. Accordingly, cohesion acts on between the elements, and the elements can endure force while maintaining the hexagonal shapes of the network-shaped main body portions 10.

Furthermore, since the lower connectors 50 are coupled from the lower ends of the columns, the columns are prevented from being excessively dug into the surface of the land due to load. Such an action functions to prevent the columns 20 from pressing the roots of grass and also to protect grass.

Furthermore, the lower connectors 50 are slantingly configured to gather upwardly, and the lower protrusions 60 are configured at the upper ends of the lower connectors 50. Accordingly, an object having a small size can be prevented from being introduced into the center of the hexagonal network-shaped main body portions 10 and from pressing grass. Furthermore, although excessive force is applied to the grass protection mat and thus the support wall bodies 30 and the upper protrusions 40 are pressed, the lower protrusions 60 formed under the support wall bodies 30 and the upper protrusions 40 function to endure secondarily pressing force.

Furthermore, since the lower connectors 50 are slantingly protruded to have elasticity to the inclined degree, a general feeling of smooth elasticity can be achieved when heavy force is applied. When the central parts of the lower connectors 50 touch the ground due to pressure, load is distributed over the lower connectors 50 from the time of touch, thus preventing the columns 20 from digging into the ground and thus generally functioning as a stable support.

The grass protection mat according to the present invention is advantageous in that it provides a smooth cushion and a stable and safe walk because the network-shaped main body portions, the support wall bodies, and the columns maintain the shape of the grass protection mat while effectively enduring stepped pressure and the upper protrusions have elasticity whenever a foot touches the grass protection mat.

In particular, according to the present invention, although stepped pressure is applied from at any location or at any angle, pressure is uniformly applied to and stably supported by the support wall bodies. Accordingly, the support wall bodies can endure force that pushes the support wall bodies in a lateral direction without being bent back. Although pressure is slantingly applied in an inclined direction, the middles of the columns are coupled by the network-shaped main body portions and the lower ends of halves of the columns are also coupled by the lower connectors. Accordingly, since a well weaved organization, such as a network, endures force, very long lifespan can be expected.

Furthermore, the lower connectors prevent the columns from being excessively dug into the surface of the land due to load. Such an action can prevent the columns from pressing the roots of grass and also protect grass. Furthermore, since the lower protrusions 60 are configured at the upper ends of the lower connectors 50, an object having a small size can be prevented from being introduced into the center of the hexagonal network-shaped main body portions and from pressing grass. Furthermore, although excessive force is applied to the grass protection mat, the lower protrusions function to endure secondarily pressing force.

As described above, the grass protection mat according to the present invention provides a very useful grass protection mat of a new dimension by increasing lifespan due to a solid construction, enabling people to step on the grass protection mat conveniently and safely, and greatly helping in protecting grass and lawns.

1. A grass protection mat, comprising:
in constructing the grass protection mat,
networked main body portions in which hexagons are continuously repeated;
a tetragonal border finishing edges;
columns each vertically formed at each hexagonal corner of the main body portions;
wall support bodies configured on upper surfaces of the networked main body portions in such a way as to be lower than the columns;
upper protrusions configured on upper surfaces of the networked main body portions in such a way as to be higher than the columns; and
Y-shaped lower connectors configured to gather three columns, from among six columns forming a hexagon, in a center of the hexagon at lower ends of the columns,
wherein the network-shaped main body portions coupled in a hexagonal form and the lower connectors that cross the network-shaped main body portions on a lower side are coupled in a hexagonal form when being seen at a top.

2. The grass protection mat of claim 1, wherein:
the support wall bodies and the upper protrusions are configured at a ratio of 1:2,
in an arrangement of the support wall bodies and the upper protrusions, in the hexagon shape of the network-shaped main body portions, the support all bodies are consecutive in one string of a portion in which a [symbol] -shaped portion and a [symbol] -shaped portion are continuous in zigzags, and the upper protrusions are continuous in a next string, and
the support wall bodies or the upper protrusions are connected to a portion where the string in which the support wall bodies are continuous and the string in which the upper protrusions are continuous are coupled at constant intervals, thus forming a Y-shaped or a Y-shaped form having up and down opposite forms.

3. The grass protection mat of claim 1, wherein:
the lower connectors are slantingly connected at the lower ends of the columns upwardly,
the lower protrusion upwardly protruded is configured at a portion where the lower connectors are gathered, and
the lower protrusion is configured to have height lower than an upper end of the upper protrusion.

4. The grass protection mat of claims 1, wherein:
protruding coupling pieces are formed at [symbol] -shaped two sides of the border,
coupling holes to which the coupling pieces are internally connected are formed at [symbol] -shaped two sides on the other side, wherein the coupling piece is protruded from the border and is circularly configured to have a groove for contraction, and
a latching protrusion for preventing detachment of the latching protrusion after being inserted into the coupling hole is formed on a side of the coupling piece.
